(19) United States
(12) Patent Application Publication
(10) Pub. No.: US 2025/0205862 A1
(43) Pub. Date: Jun. 26, 2025

(54) METHOD AND ARRANGEMENT FOR TIGHTENING A SCREW CONNECTION

(71) Applicant: DEERE & COMPANY, MOLINE, IL (US)

(72) Inventors: JOHANNES BRUNS, MANNHEIM (DE); TOBIAS TRUNK, MOSBACH (DE); FLORIAN FOEHLISCH, HEIDELBERG (DE); TIMO NIEBEL, KARLSRUHE (DE)

(21) Appl. No.: 18/922,739

(22) Filed: Oct. 22, 2024

(30) Foreign Application Priority Data
Dec. 20, 2023 (DE) 102023136021.3

(51) Int. Cl. B25B 23/142

(52) U.S. Cl. CPC B25B 23/1425

(57) ABSTRACT

A method for tightening a screw connection between a first and a second component which are equipped with interacting threads including rotating one of the threads to tighten the screw connection, successively detecting the angle of rotation via an angle sensor and detecting the torque via a torque sensor during tightening of the screw connection, evaluating the signals of the angle sensor and the torque sensor via an electronic processing device to determine one or more characteristic features of the signals and comparing the one or more characteristic features with one or more reference values, identifying via the electronic processing device on the basis of the comparison whether an intermediate element is inserted and clamped as intended between the first and second components, and emitting via the electronic processing device a fault notification when the result of the comparison is that the intermediate element is absent or is inserted incorrectly.

### CROSS-REFERENCE TO RELATED APPLICATIONS

This application claims priority to German Patent Application No. 102023136021.3, filed Dec. 20, 2023, which is hereby incorporated by reference.

### FIELD OF THE DISCLOSURE

The disclosure relates to a method and an arrangement for tightening a screw connection between a first component and a second component which are equipped with interacting threads.

### BACKGROUND

Screw connections are usually provided in the case of the production or repair of components, assemblies, and whole machines or vehicles in order to connect two elements to each other in particular detachably. The screw connection comprises a first structural element (nut, socket, or the like) with an internal thread and a second structural element (screw, bolt, or the like) with an external thread complementing the internal thread.

### SUMMARY

In most cases, intermediate elements are provided in the axial direction between the first and second structural element which serve, when the thread is tightened, to provide a defined bearing surface for the structural elements (for example, washers) and/or to seal the connection (sealing rings). In the tightened state of the screw connection, the intermediate element accordingly bears against both the first and the second structural element and is clamped between the structural elements in the axial direction (i.e. the direction in which the first or second structural element moves linearly relative to the in each case other structural element when the screw connection is tightened), and to be precise with a force which is dependent on the tightening torque.

So-called torque wrenches are used to firmly tighten the screw connection in order to ensure defined and reproducible tightening torques. For example, these include a mechanical element (overload coupling) which disconnects the frictional connection between an input and the output detachably coupled to the rotated structural element when a torque which can be set is reached. The input can be a manually handled lever or be actuated by an external force (a motor) and the output can comprise an internal or external hexagon wrench or an open-ended wrench as an interface with the rotated structural element. In advanced torque wrenches, a sensor for detecting the torque is used which detects, for example, the torque-dependent deformation of a mechanical element interposed in the frictional connection between the input and the output. An electronic evaluation system emits a signal which alerts the operator when a specifiable reference torque is reached.

In even more advanced torque wrenches, not only is the transmitted torque detected but also the associated angle of rotation. An inertia sensor can be used to do this or the angle between the input and output is measured.

Reference should be made here, for example, to JP S 591172 A. It is proposed there first to tighten the screwed connection until a first torque is reached at which the structural elements come to bear against each other, and then to rotate it further by a defined angle, a corresponding warning signal being emitted to an operator so that the latter stops the tightening in order to ensure the defined screwed connection.

US 2022/0214240 A1 furthermore proposes to equip a torque wrench, equipped with an angle and torque sensor and an electronic evaluation and display unit, with a wireless data transmission device in order to be able to specify, by means of a separate input and output device, the maximum torque and the angle of rotation corresponding to the screwed connection to be tightened in each case. When the specified torque or the specified angle has accordingly been reached, the operator receives a corresponding signal from the display unit of the torque wrench. These values are also fed back to the separate input and output device and recorded there and are optionally displayed or used in order to check whether the correct torque profile has been used.

Optical identification of whether the sealing ring is situated at the desired position as part of an assembly process is described in DE 11 2017 005 961 T5.

As mentioned at the beginning, in most cases intermediate elements (washers, sealing rings, etc.) are used between the structural elements. Situations are conceivable, in particular in manufacturing processes (an assembly line) or in the case of repair work, in which the intermediate element is absent (for example, has been forgotten or has fallen off) or has been positioned incorrectly such that it is not situated at the desired location, for example in a groove, such that it is crushed when the screw connection is tightened. In these situations, the known torque wrenches would not identify the problem and instead would tighten the connection nevertheless with the specified torque and angle. The problem may only be noticed later when, for example, liquids escape or a desired strength of the fastening is not achieved. The references cite the optical detection of the intermediate element as a solution for this problem.

The object on which the disclosure is based avoids at least some of the disadvantages mentioned.

This object is achieved according to the disclosure by the teachings of one or more embodiments described herein, wherein features advantageously refining the achievement of the object are set forth in one or more embodiments described herein.

A method and an arrangement for tightening a screw connection between a first component and a second component which are equipped with interacting threads comprise the following steps or means for carrying them out:
rotating one of the threads so as to tighten the screw connection;
successively detecting the angle of rotation by means of an angle sensor and detecting the torque by means of a torque sensor during the tightening of the screw connection; and
evaluating the signals of the angle sensor and the torque sensor by means of an electronic processing device for the purpose of determining one or more characteristic features of the signals and comparing the feature or features with one or more reference values;
wherein the electronic processing device identifies on the basis of the comparison whether an intermediate element is inserted between the first and second component and, when the screw connection is tightened, is clamped as intended between the first and second component and, if the result of the comparison is that the intermediate element is absent or is inserted incorrectly, emits a fault notification.

In other words, it is proposed to detect the angle and the torque over time when the screw connection is tightened (firmly), i.e. the measured values for the angle and torque are recorded at certain time intervals. One or more characteristic features of the signals, such as the curve shape (progression) and/or curve height and/or curve gradient of the torque plotted as a function of the angle, are calculated on the basis of the measured values and, by means of a comparison of the feature or features with one or more reference values, which can represent, for example, correctly or incorrectly installed or uninstalled intermediate elements, it is possible to identify by means of an electronic processing device whether the intermediate element is present or absent. It can optionally also be identified if the intermediate element is installed incorrectly, i.e. is, for example, tilted or is not situated in a groove. If the intermediate element is absent or is arranged incorrectly, the processing device emits a fault signal. The latter can be displayed to an operator or be used by an independent arrangement in order to correct the fault.

Different approaches are conceivable for providing the reference values. On the one hand, the torque can be measured as a function of the angle at one or more comparable or similar screw connections which is or are not faulty. In this way, a reference curve is obtained, from which characteristic features can be derived, which is then compared with the characteristic features of the tightened screw connection which is to be assessed. On the other hand, it is also possible to determine the reference curve and/or reference values on the basis of theoretical considerations, simulations, or calculations. It is also possible, for example, to calculate by finite element calculations a reference curve for torques which are to be expected as a function of the angle, based on data of the screw connection such as thread dimensions, thread pitches, flank angles, materials, coefficient of friction, coefficient of elasticity, etc.

The above and other features will become apparent from the following detailed description and accompanying drawings.

### BRIEF DESCRIPTION OF THE DRAWINGS

An exemplary embodiment of the disclosure will be explained on the basis of the drawings, in which:

FIG. 1 shows a schematic drawing in cross section of a screw connection;

FIG. 2 shows a schematic illustration of a torque wrench;

FIG. 3 shows a diagram of recorded torques as a function of the angle of rotation when tightening screw connections;

FIG. 4 shows a graph of the angular dependency of the torque when the screw connection is firmly tightened;

FIG. 5 shows a bar chart for gradients of the torque in different situations; and

FIG. 6 shows a flow chart for the procedure when tightening the screw connection.

### DETAILED DESCRIPTION

The embodiments or implementations disclosed in the above drawings and the following detailed description are not intended to be exhaustive or to limit the present disclosure to these embodiments or implementations.

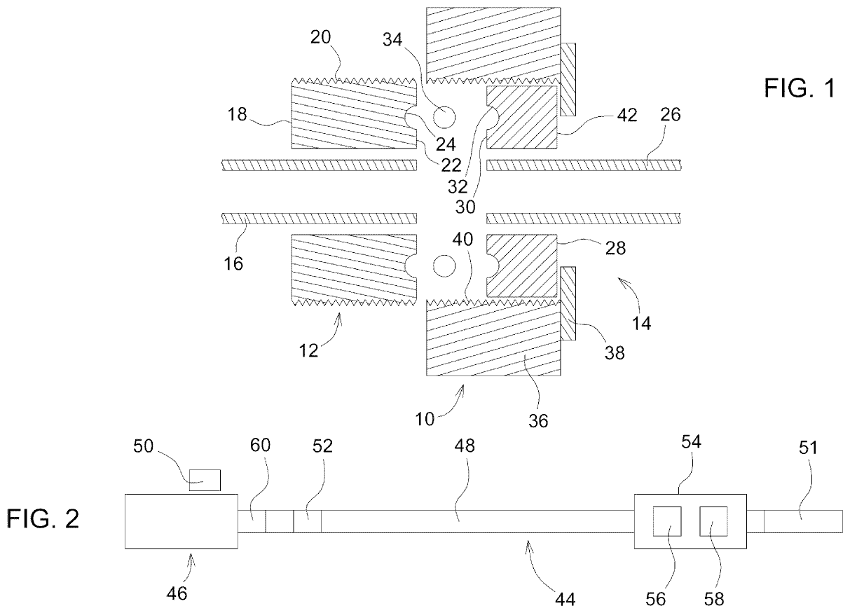

FIG. 1 shows an example for a screw connection 10 between a first component 12 and a second component 14 in an unassembled state. The first component 12 comprises a pipe 16 through which a liquid or a gas can be conveyed, and a first hollow part 18, firmly attached to the pipe 16, with an external thread 20. The first hollow part 18 is provided with a groove 24 at its outer end face 22. The second component 14 also comprises a pipe 26 to which a second hollow part 28 is fastened. The second hollow part 28 also comprises a groove 32 at its outer end face 30. A union nut 36 with a rear collar 38 which bears against the rear face 42 (remote from the end face 30) of the second hollow part 28 is equipped with an internal thread 40.

FIG. 1 shows the screw connection 10 in the disassembled state. It can be seen that a sealing ring 34, which provides a seal in the tightened state of the union nut 36, can be positioned inside the grooves 24, 32, between the end faces 22, 30 of the hollow parts 18, 28. The hollow parts 18, 28 are also coupled (for example, welded, bonded, or crimped) to the pipes 16 and 26, respectively, in such a way that no liquid or gas can escape there. The threads 20 and 40 interact in such a way that, when the union nut 36 is tightened, the sealing ring 34 is compressed with a certain definable axial force (acting in a horizontal direction in FIG. 1).

FIG. 2 shows a torque wrench 44 in a schematic illustration. It comprises an interface 46 for producing a torque-transmitting connection to the union nut 36, a lever arm 48 with a handle 51, and an angle sensor 50, a torque sensor 52, and an electronic unit 54 with an electronic processing device 56 (e.g., a controller including a processor and memory) and a display device 58. An adjustable connection 60 can be arranged between the interface 46 and the lever arm 48, which adjustable connection enables, inter alia for ergonomic reasons, pivoting of the lever 48 relative to the interface 46 in the plane of the drawing in FIG. 2 and/or restoring of the lever 48 (for example, by means of a ratchet) relative to the interface 46 once the screw connection has been rotated by means of the union nut 36 by a certain angle. The angle sensor 50 and the torque sensor 52 are connected to the processing device 56 and the display device 58 so that signals can be transmitted (by cable or wirelessly). The processing device 56 and possibly the display device 58 could also be arranged remotely from the torque wrench 44. Reference should be made for the fundamental mechanical and electronic structure of the torque wrench 44 also to JP S 591172 A and US 2022/0214240 A1, which are hereby incorporated by reference.

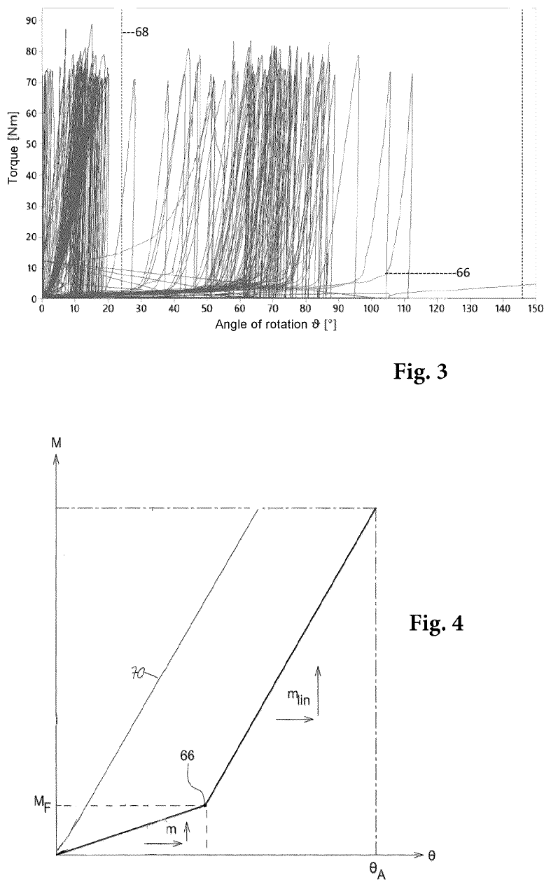

FIG. 3 shows examples for torques M recorded in practice (y axis) as a function of the angle theta (x axis). Essentially two groups of curves can be distinguished, namely the one in the left-hand area (below the vertical line 68) and the one in the right-hand area on the other side of the line 68. The curves which may be seen only in the left-hand area have a relatively high gradient. They essentially first run parabolically or exponentially and later more or less linearly. Those curves which are also situated on the other side of the line 68 initially run relatively flat (the sealing ring 34 is compressed here) and comprise a point at which the gradient rises sharply. This point can be identified as the joining point 66 at which two metal faces (the end faces 22, 30 in the example of FIG. 1) come to bear against each other. The gradient on the other side of the joining point 66 corresponds approximately also to the gradient of the curves which can be seen in the left-hand area in which the sealing ring 34 is absent.

FIG. 4 schematically illustrates the torques M (y axis) which are to be expected as a function of the angle theta (x axis) when the screw connection is tightened. Starting from a zero angle and torque, (when the sealing ring 34 is correctly assembled) initially a relatively small gradient m of the torque, approximated by a straight line and which is caused by the friction of the threads 20, 40 and the elasticity of the sealing ring 34, results until the joining torque MF is reached at a point 66 at which the outer end faces 22, 30 come to bear against each other directly mechanically. Beyond this point, the torque M rises approximately linearly with the angle theta with an approximately constant gradient mlin. At the angle thetaA (A represents the tightening angle at which the tightening ends), the tightening process ends because the screw connection is then tightened sufficiently firmly. If, in contrast, the sealing ring 34 is absent or is assembled incorrectly, the curve 70 drawn on the left results with significantly higher gradients in the starting area (the area with a flat gradient which is created in the case of the curve drawn on the right in FIG. 4 by the deformation of the sealing ring 34 is absent) and later approximately the same gradient as in the case of the right-hand curve beyond the point 66 at which the joining torque is reached (these gradients result primarily from the restoring forces built up by the tension of the threads 20, 40) but with greater absolute values.

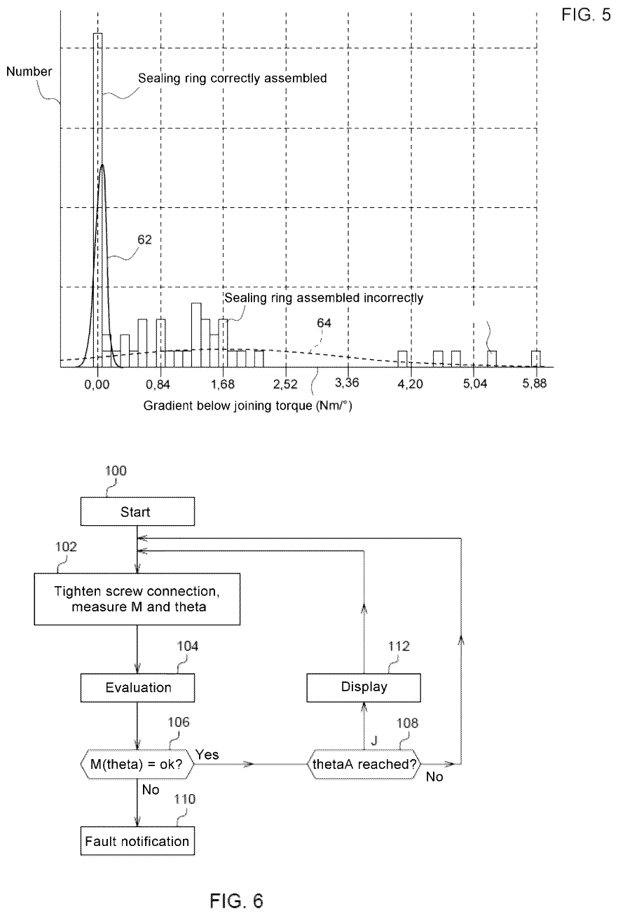

FIG. 5 shows a bar chart in which the gradient m, i.e. the torque measured by the torque sensor 52, divided by the angle detected by the angle sensor 50, before the joining torque MF, is reached, is represented on the x axis, whilst the associated frequency is shown on the y axis. If the sealing ring 34 has been installed correctly, the gradient m is relatively small, which is due to the fact that the sealing ring 34 made from elastomeric material lies in the grooves 24, 32 and is gradually compressed. The associated distribution can be approximated by a first (bell) curve 62. However, situations also occur in which the sealing ring 34 has been incorrectly installed and is crushed when the screw connection is tightened, or in which it is completely absent. In these situations, the gradient m is significantly greater because the end faces 22, 32 come into contact with each other sooner than in the case of a correctly installed sealing ring 34 or directly. The associated distribution can be approximated by a second curve 64, the maximum point of which lies with significantly higher gradients m than in the case of the first curve 62.

In light of the above, it is proposed that the processing device 56 of the torque wrench 44 of FIG. 2 works in accordance with the flow chart of FIG. 6.

The process begins with an initialization in step 100 at which, for example, information about the screw connection to be produced is taken by the processing device 56 from a database which is stored in the processing device 56, and can be called up on the basis of an identifier which is identified automatically, for example by a computer-assisted (manufacturing) process control system by means of remote data transmission such as Bluetooth or WLAN or by means of an RFID chip of the screw connection or by means of a camera, or is input manually.

In the next step 102, the screw connection is then tightened, as described above, and the torque M and the angle theta are detected over time by means of the sensors 50, 52 and fed to the processing device 56.

An evaluation takes place in the following step 104. One or more of the pieces of data detected in step 102 can thus be evaluated. First, preprocessing takes place in which implausible data are rejected and only data which lie above a certain minimum torque continue to be used. In addition, approaches which are known per se can be used to remove outliers and noise and, for example, to determine mean values, for example for gradients, by linear regression.

The preprocessed measured values, recorded over time, for the angle and the torque are evaluated in order to determine characteristic features of the curves for the angular dependency of the torque. These features are then compared with reference values in order to identify whether the tightening process of the screw connection is taking place correctly or not.

In one embodiment, a comparison can be made between the gradient m as far as the point at which the joining torque MF is reached (i.e. before the point 66 of FIGS. 3 and 4 is reached) with stored reference values taken from the database. Alternatively or additionally, the reaching of the joining torque MF (i.e. reaching the point 66 of FIGS. 3 and 4) can be identified on the basis of the gradient which changes there and be compared with stored reference values, taken from the database, for the joining torque MF. Alternatively or additionally, the gradient mlin after the joining torque MF is reached (i.e. after the point 66 of FIGS. 3 and 4 is reached) can be detected and be compared with stored reference values taken from the database.

It can accordingly be identified by the processing device 56 on the basis of characteristic features of the progression of the measured torque and angle whether the tightening of the screw connection is progressing correctly or not. Recourse could also be made here to acquired knowledge of an artificial intelligence which is fed with a sufficiently large amount of comparative data or only detects data during work initially for learning purposes and, after a learning phase, is capable of identifying correct tightening of the screw connection. Alternatively, recourse can be made to measurement series or theoretical calculations for calculating the reference values of the characteristic features.

If it is found in the step 106 following step 104 that the torque progression corresponds to a correctly installed sealing ring 34, step 108 follows in which a check is made as to whether the angle thetaA to be set has been reached and, if this is not the case, step 102 is repeated. The torque and the angle, as well as the characteristic features derived therefrom (here in particular the gradient m) are accordingly detected almost continuously (or at regular time intervals) and compared with reference values.

If it is found in step 108 that the angle thetaA to be set has been reached, step 112 follows in which an indication is given by means of the display device 58 (and/or acoustically) that the operator can end the process, whereupon step 102 is repeated in which a further screw connection is tightened.

If, in contrast, it is found in step 106 that the torque progression is not progressing in the fashion expected for a correctly installed sealing ring 34, an indication is given in step 110 by means of the display device 58 (and/or acoustically) that the screwing process is not progressing correctly and the sealing ring is absent or has been placed incorrectly. The operator can accordingly disassemble the screw connection and insert or replace the sealing ring 34.

In the embodiment described, the checking of the screwing process takes place continuously over the whole screwing process. Alternatively, the steps 104 and 106 from FIG. 6 can also take place after thetaA has been reached (step 108) on the basis of all of the measured data that exist about the screw connection in question.

It should also be noted that the screw connection according to FIG. 1 represents just one example. The screw connection 10 could also be configured as a normal screw which extends through openings in two components 12, 14 to be fastened and is fastened by means of a washer and a nut bearing thereon. In this case, the processing device 56 would be capable of identifying an absent or incorrectly installed washer. Any other embodiments of the screw connection are conceivable.

In addition, the torque wrench 44 is just one example for an arrangement for tightening a screw connection with a defined torque. Accordingly, an input which is actuated by an external force and rotates the interface 46 with a torque and angle which can be measured by sensors 50, 52 could be used instead of the lever 48 and the handle 51. This input could be held by the arm of an operator or by a robot arm. In this case, the processing device 56 would be capable of automatically stopping the input in step 110 or of reversing its direction of rotation.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for tightening a screw connection between a first component and a second component which are equipped with interacting threads, comprising:
rotating one of the threads so as to tighten the screw connection;
successively detecting the angle of rotation via an angle sensor and detecting the torque via a torque sensor during the tightening of the screw connection;
evaluating the signals of the angle sensor and the torque sensor via an electronic processing device for the purpose of determining one or more characteristic features of the signals and comparing the one or more characteristic features with one or more reference values;
identifying via the electronic processing device on the basis of the comparison whether an intermediate element is inserted between the first and second components and is clamped as intended between the first and second components when the screw connection is tightened; and
emitting via the electronic processing device a fault notification when the result of the comparison is that the intermediate element is absent or is inserted incorrectly.

2. The method of claim 1, wherein the intermediate element is a sealing ring or a washer.

3. The method of claim 1, wherein the fault notification is displayed on a display device.

4. The method of claim 1, wherein the electronic processing device identifies the absent or incorrectly inserted intermediate element on the basis of a gradient of the torque as a function of the angle as far as the point at which a joining torque is reached at which the gradient changes because of a direct mechanical contact which results between the two components.

5. The method of claim 1, wherein the electronic processing device identifies the absent or incorrectly inserted intermediate element on the basis of a gradient of the torque as a function of the angle after the joining torque has been reached.

6. The method of claim 1, wherein the electronic processing device identifies the absent or incorrectly inserted intermediate element on the basis of the value of the joining torque.

7. The method of claim 1, wherein the electronic processing device identifies the absent or incorrectly inserted intermediate element on the basis of one or more of the following characteristic features calculated on the basis of the signals of the angle sensor and the torque sensor, compared with one or more reference values:
a gradient of the torque as a function of the angle as far as the point at which a joining torque is reached at which the gradient changes because of a direct mechanical contact which results between the two components;
a gradient of the torque as a function of the angle after the joining torque has been reached; and
the value of the joining torque.

8. The method of claim 1, wherein the angle sensor, the torque sensor, and the electronic processing device are installed in a torque wrench.

9. The method of claim 1, wherein information about the screw connection can be fed to the electronic processing device and the electronic processing device takes reference values, required for the comparison, from a database on the basis of the information.

10. The method of claim 1, wherein the reference values used by the electronic processing device are based on one or more of measurements and calculations.

11. An arrangement for tightening a screw connection between a first component and a second component which are equipped with interacting threads, comprising:
a torque wrench configured to rotate one of the threads so as to tighten the screw connection,
an angle sensor and a torque sensor for successively detecting the angle of rotation and the torque during the tightening of the screw connection, and
an electronic processing device configured to evaluate the time-dependent signals of the angle sensor and the torque sensor for the purpose of determining one or more characteristic features of the signals and comparing the feature or features with one or more reference values, identify whether an intermediate element is inserted between the first and second components on the basis of the comparison and is clamped as intended between the first and second components when the screw connection is tightened, and emit a fault notification when the result of the comparison is that the intermediate element is absent or is inserted incorrectly.

12. The arrangement of claim 11, wherein the intermediate element is a sealing ring or a washer.

13. The arrangement of claim 11, wherein the fault notification is displayed on a display device.

14. The arrangement of claim 11, wherein the electronic processing device identifies the absent or incorrectly inserted intermediate element on the basis of a gradient of the torque as a function of the angle as far as the point at which a joining torque is reached at which the gradient changes because of a direct mechanical contact which results between the two components.

15. The arrangement of claim 11, wherein the electronic processing device identifies the absent or incorrectly inserted intermediate element on the basis of a gradient of the torque as a function of the angle after the joining torque has been reached.

16. The arrangement of claim 11, wherein the electronic processing device identifies the absent or incorrectly inserted intermediate element on the basis of the value of the joining torque.

17. The arrangement of claim 11, wherein the electronic processing device identifies the absent or incorrectly inserted intermediate element on the basis of one or more of the following characteristic features calculated on the basis of the signals of the angle sensor and the torque sensor, compared with one or more reference values:
a gradient of the torque as a function of the angle as far as the point at which a joining torque is reached at which the gradient changes because of a direct mechanical contact which results between the two components;
a gradient of the torque as a function of the angle after the joining torque has been reached; and
the value of the joining torque.

18. The arrangement of claim 11, wherein the torque wrench includes the angle sensor, the torque sensor, and the electronic processing device.

19. The arrangement of claim 11, wherein information about the screw connection can be fed to the electronic processing device and the electronic processing device takes reference values, required for the comparison, from a database on the basis of the information.

20. The arrangement of claim 11, wherein the reference values used by the electronic processing device are based on one or more of measurements and calculations.
